(19) United States
(12) Patent Application Publication
(10) Pub. No.: US 2023/0380459 A1
(43) Pub. Date: Nov. 30, 2023

(54) PRESERVATION METHOD OF FRESH TREMELLA FUCIFORMIS SUITABLE FOR COLD-CHAIN CIRCULATION

(71) Applicant: Institute of Agricultural Engineering Technology, Fujian of Agricultural Sciences, Fuzhou (CN)

(72) Inventors: Pufu LAI, Fuzhou (CN); Junchen CHEN, Fuzhou (CN); Minjie WENG, Fuzhou (CN); Baosha TANG, Fuzhou (CN); Yibin LI, Fuzhou (CN); Li WU, Fuzhou (CN); Zheng XIAO, Fuzhou (CN); Yanrong YANG, Fuzhou (CN)

(21) Appl. No.: 18/049,482

(22) Filed: Oct. 25, 2022

Related U.S. Application Data
(63) Continuation-in-part of application No. PCT/CN2022/111122, filed on Aug. 9, 2022.

(30) Foreign Application Priority Data
May 27, 2022 (CN) 202210590891.5

(51) Int. Cl. A23L 3/36; B65D 81/18

(52) U.S. Cl. CPC A23L 3/361; B65D 81/18

(57) ABSTRACT

A preservation method of fresh tremella fuciformis suitable for cold-chain circulation includes pretreatment of fresh tremella fuciformis: selecting fresh tremella fuciformis with no mildew, no rot, no disease and insect pests, and water content≤90% to enter subsequent cold-chain circulation; precooling: precooling the pretreated fresh tremella fuciformis put in a cold store at 1° C.-3° C., or performing vacuum precooling on the pretreated fresh tremella fuciformis; packaging, wherein a temperature of a packaging operation room of the fresh tremella fuciformis is less than or equal to 18° C., and time of the fresh tremella fuciformis from entering the packaging operation room to the completion of packaging does not exceed 1 h; storage: storing the packaged fresh tremella fuciformis immediately, controlling a storage temperature to 1° C.-3° C., and performing cold-chain transportation within 24 h; and cold-chain transportation: performing transportation by a refrigerated vehicle or by adding ice packs.

### FIELD

The present disclosure belongs to the technical field of preservation of fresh tremella fuciformis, and in particular, relates to a preservation method of fresh tremella fuciformis suitable for cold-chain circulation, which is suitable for packaging, storage and cold-chain transportation of fresh tremella fuciformis subjected to substitute cultivation.

### BACKGROUND

Tremella fuciformis is a fruiting body of fungi in basidiomycota, tremellomycetes, tremellales, tremellaceae and tremella, and is also known as white fungus, snow fungus, white jelly mushroom, etc. Tremella fuciformis is an edible and medicinal fungus, and is rich in nutrients such as sugar, protein, fat, vitamins and minerals, including several essential amino acids for human growth. Tremella fuciformis is known as the “champion in fungi” and is listed as one of the four treasures “ginseng, cartialgenous, cubilose and tremella fuciformis”.

Due to the excessively high moisture of harvested fresh tremella fuciformis, if there is no corresponding preservation technology and conditions, it is necessary to dry the fresh tremella fuciformis immediately. The methods for drying fresh tremella fuciformis widely used at present include hot air drying and natural drying. In order to solve the problem of yellowing of the fresh tremella fuciformis during drying, by comprehensively considering the cost factor, sulfur processing has become the best choice for farmers in Gutian county; however, when the process is applied, there will always be food safety problems such as SO₂ exceeding the standard, thereby seriously threatening the health of consumers.

The traditional sales method of tremella fuciformis is mainly in the form of dried products. In recent years, the industrial structure of tremella fuciformis has been changing quietly. In particular, fresh tremella fuciformis that has not been dried is delivered to users through standardized refrigeration, transportation and packaging, thereby ensuring the hygienic and quality requirements of the fresh tremella fuciformis. By reasonable cooking, the gelatinous, thick, tender and delicate taste of the fresh tremella fuciformis has been widely recognized. The proportion of fresh tremella fuciformis increases year by year, breaking the previous situation that dried tremella fuciformis dominates the market. Fresh tremella fuciformis is delivered to physical supermarkets through cold-chain logistics or directly delivered to consumers through E-commerce express, so that the ready sales of the fresh tremella fuciformis in domestic markets is realized, thereby effectively improving the brand value of tremella fuciformis, promoting the prosperity of the market, meeting the demand of consumption, increasing production and income of farmers, and playing a positive role in benefiting and enriching farmers. However, since the water content of fresh tremella fuciformis is as high as 90%, the fresh tremella fuciformis is prone to rot and mildew in the packaging, storage and transportation process after harvest, particularly, toxin “bongkrekic acid” is likely to be produced. The bongkrekic acid is produced by a bacterium called pseudomonas cocovenenans subspfarinofermentans, which is heat resistant. The toxicity of the bacterium cannot be destroyed by ordinary cooking, the bacterium cannot be removed by specific antidote, and can cause liver and kidney damage, organ failure and death.

Fresh tremella fuciformis is becoming more and more popular at present. However, the problem of bongkrekic acid toxin pollution that the spoiled fresh tremella fuciformis may suffer from is still present in the storage and transportation link. In the fresh sales or e-commerce trading mode of the physical supermarket, the storage, packaging and transportation links of fresh tremella fuciformis products are the key points to ensure the product quality. The current fresh tremella fuciformis sales enterprises lack unified standards in the process of postharvest preservation, packaging, storage and transportation, and are mostly voluntary, thereby affecting the quality guarantee and added value of tremella fuciformis, and having hidden dangers of food hygiene and quality safety.

### SUMMARY

For the above technical problems, the present disclosure provides a preservation method of fresh tremella fuciformis suitable for cold-chain circulation. The method is simple and practical, high in operability, and capable of effectively controlling the production of bongkrekic acid toxin, thereby ensuring the quality safety of the fresh tremella fuciformis.

The present disclosure is implemented by the following technical solutions.
the preservation method of fresh tremella fuciformis suitable for cold-chain circulation, wherein the fresh tremella fuciformis is a fresh tremella fuciformis fruiting body with and without tremella bases or with fungal sticks, and the method comprises:
pretreatment of fresh tremella fuciformis: selecting fresh tremella fuciformis with no mildew, no rot, no disease and insect pests, and water content≤90% to enter subsequent cold-chain circulation, wherein the pretreatment time of the fresh tremella fuciformis does not exceed 2 h;
precooling: precooling the pretreated fresh tremella fuciformis put in a cold store at 1° C.-3° C., wherein a center temperature of the fresh tremella fuciformis at a stack center is precooled to 3° C.-5° C. within 5 h; or performing vacuum precooling on the pretreated fresh tremella fuciformis, wherein the center temperature of the fresh tremella fuciformis at a stack center is precooled to 3° C.-5° C. within 40 min;
packaging: a temperature of a packaging operation room of the fresh tremella fuciformis is less than or equal to 18° C., time of the fresh tremella fuciformis from entering the packaging operation room to the completion of packaging does not exceed 1 h, and packaging is completed within 48 h after precooling;
storage: storing the packaged fresh tremella fuciformis immediately, controlling a storage temperature to 1° C.-3° C., and performing cold-chain transportation within 24 h; and
cold-chain transportation: transporting the fresh tremella fuciformis by a refrigerated vehicle or by adding ice packs, and treating or refrigerating and freezing the fresh tremella fuciformis timely after the fresh tremella fuciformis arrives at a destination, refrigerated storage is inadvisable to exceed 7 days, and frozen storage is inadvisable to exceed 30 days.

Further, the pretreatment step of the fresh tremella fuciformis comprises:
selecting a clean and dry hollow plastic turnover box that complies with the regulations of GB/T 39907 to place fresh tremella fuciformis with and without tremella bases; or selecting a clean and dry shelf to place fresh tremella fuciformis with fungal sticks, wherein a width of the shelf is greater than or equal to 30 cm, a height of the shelf is less than or equal to 200 cm, and a height between adjacent layers of each shelf is greater than or equal to 25 cm;
transversely placing the fresh tremella fuciformis with tremella bases layer by layer in a manner of tremella base to tremella base, with no more than 5 layers in each box; when there are 5 layers in each box, the tremella bases on the first layer face downward, the tremella bases on the second layer and the fourth layer face upward, and the tremella bases on the third layer and the fifth layer face downward;
randomly arranging the fresh tremella fuciformis without tremella bases, with a stacking height that does not exceed 30 cm; and
laterally placing the fresh tremella fuciformis with fungal sticks layer by layer in a manner of tremella slice crossed to tremella slice and stick back to stick back, with no more than 3 layers in each box; or placing the fresh tremella fuciformis side by side on the shelf in a manner of the tremella bases facing downwards, with one layer of the fresh tremella fuciformis placed on each layer of shelf.

Further, in the precooding step:
during precooling in the cold store: precooling the fresh tremella fuciformis placed and stacked in the hollow plastic turnover box, and controlling a distance between a stack and a wall to be greater than or equal to 30 cm, a distance between the stack and the ground to be greater than or equal to 10 cm, a distance between the stack and a top lighting lamp to be greater than or equal to 50 cm, a distance between the stack and an air cooler to be greater than or equal to 150 cm, a distance between stacks to be greater than or equal to 30 cm and a stack height to be less than or equal to 200 cm; precooling the fresh tremella fuciformis placed on the shelf, and controlling a distance between the shelf and a wall to be greater than or equal to 30 cm, a distance between the shelf and a top lighting lamp to be greater than or equal to 50 cm, a distance between the shelf and an air cooler to be greater than or equal to 150 cm and a distance between shelves to be greater than or equal to 30 cm; and during vacuum precooling, a loading rate should not be exceeded 70%, and a vacuum degree should be maintained between 650 Pa and 750 Pa.

Further, packaging materials used in the packaging step comprise an internal packaging material and an external packaging material;
a plastic packaging container or packaging paper is used as the internal packaging material; the plastic packaging container complies with the regulations of GB/T 34343, a quantity of holes punched in a surface of each plastic packaging container is greater than or equal to 4, and an area of each hole is greater than or equal to 0.25 cm²; the packaging paper complies with the regulations of NY/T 658-2015 5.4; and
a foam logistics packaging container, a plastic logistics packaging container or a carton is used as the external packaging material; the foam logistics packaging container and the plastic logistics packaging container comply with the regulations of GB/T 34344; and the carton transported by adding the ice packs complies with the regulations of GB/T 6543, and the carton transported by the refrigerated vehicle complies with the regulations of GB/T 31550.

Further, in the packaging step:
a packaging method for the fresh tremella fuciformis with and without tremella bases is as follows:
internal packaging: fresh tremella fuciformis with and without a tremella base is subjected to or not subjected to internal packaging; during internal packaging, each transparent plastic packaging container is filled with one or more fresh tremella fuciformis, and each piece of packaging paper packs one fresh tremella fuciformis with the tremella base;
external packaging: the foam logistics packaging container or the plastic logistics packaging container is used for single-layer packaging, or the foam logistics packaging container and the carton are used sequentially from inside to outside for double-layer packaging; or
when external packaging is used in transportation by adding ice packs, the ice packs are placed inside and should be placed uniformly and neatly; each fresh tremella fuciformis with or without the tremella base, which is subjected to internal packaging is equipped with an ice pack not less than 33 g, and each fresh tremella fuciformis with or without the tremella base, which is not subjected to internal packaging is equipped with an ice pack not less than 15 g;
a packaging method for the fresh tremella fuciformis with a fungal stick is:
internal packaging is not necessary for the fresh tremella fuciformis with the fungal stick;
external packaging: the foam or plastic logistic packaging container is used for single-layer packaging, or the foam logistics packaging container and the carton are used sequentially from inside to outside for double-layer packaging; or
when transporting the fresh tremella fuciformis with a fungal stick by adding ice packs, the ice packs are placed inside and should be placed uniformly and neatly; and each fresh tremella fuciformis with the fungal stick should be equipped with an ice pack not less than 27 g.

Further, in the storage step:
the fresh tremella fuciformis with external packaging completed should be stored immediately and is transported in cold chain within 24 h;
storage facilities, equipment and appliances should be kept clean and sanitary, and free of pollution, sundries and peculiar smell;
the storage temperature should be controlled between 1° C. and 3° C., the temperature in the cold store is observed and recorded regularly during storage, and the records should be kept for at least two years; and
the fresh tremella fuciformis is stacked in batches according to different production batches during storage, the stacking method is as same as that used in the precooling process of the cold store, and the origin, harvest time, warehousing time, warehousing quantity and warehousing people are marked.

Further, the method comprises a marking step, wherein marking is performed after the storage step, internal packaging marking refers to the regulation of Administrative Measures for the Packaging and Marking of Agricultural Products (Order of the Ministry of Agriculture, No. 70), and the receipt and delivery mark of the external packaging complies with the regulations of GB/T 6388; and the storage and transportation graphic mark of external packaging complies with the regulations of GB/T 191.

Further, in the cold-chain transportation step:
an appropriate transportation tool is selected according to the quality guarantee requirements of the fresh tremella fuciformis and customer requirements, a heat-insulating vehicle and the refrigerated vehicle comply with the regulations of QC/T 449, a refrigerated container complies with the regulations of GB/T 7392, and a railway freight car complies with the regulations of GB/T 5600;
transportation tools should be clean, sanitary, free of pollution, sundries and peculiar smell, and equipped with sunproof, rainproof and windproof facilities;
when transporting the fresh tremella fuciformis by the refrigerated vehicle, the temperature in a compartment should be precooled to 4° C. or below before loading, and the temperature in the compartment during transportation should be controlled between 0° C. and 4° C., the temperature in the compartment is monitored and recorded manually or by a temperature recorder, and the transportation information records should be kept for at least two years; and
when transporting the fresh tremella fuciformis by adding ice packs, the fresh tremella fuciformis subjected to double-layer external packaging with the foam logistics packaging container and the carton or subjected to single-layer external packaging with the foam logistic packaging container should be transported and delivered within 48 h, and the fresh tremella fuciformis subjected to single-layer external packaging with plastic logistics packaging container should be transported and delivered within 1 h.

The present disclosure has the following technical effects.

(1) In the preservation method provided by the present disclosure, it is stipulated that the water content of the fresh tremella fuciformis does not exceed 90%. Before the fresh tremella fuciformis is in cold-chain transportation, the water content may greatly affect the quality and the storage preservation effect of the fresh tremella fuciformis in cold-chain transportation. When the water content of the fresh tremella fuciformis is greater than 90%, the preservation time obviously becomes shorter, and it is more likely to breed microorganisms, resulting in autolysis and rot. Therefore, it is stipulated that the fresh tremella fuciformis should be keep the original water of the mushroom body, and the water content is inadvisable to exceed 90%.

(2) In the preservation method provided by the present disclosure, the center temperature of the fresh tremella fuciformis is precooled to 3° C.-5° C. by cold store precooling or vacuum precooling, then precooling is stopped, and the fresh tremella fuciformis is transferred to the cold store for storage, so that the freshness of the fresh tremella fuciformis can be ensured.

(3) In the preservation method provided by the present disclosure, it is stipulated that the transparent plastic packaging container or packaging paper is used as the internal packaging material, and the surface of the plastic packaging container is punched; and the punching the plastic box for packaging has the best inhibition effect on the respiratory intensity and weight loss rate of the fresh tremella fuciformis, and can better inhibit the reduction of color difference, soluble protein and soluble sugar. Besides, the fresh tremella fuciformis tends to ferment in a closed environment to produce wine taste or sour taste to affect the product quality, so the internal packaging materials used in the present disclosure have high air permeability.

(4) In the preservation method provided by the present disclosure, the storage temperature is strictly limited, 1° C.-3° C. is selected as the storage temperature for the fresh tremella fuciformis, and at the storage temperature, the respiratory intensity, the weight loss rate, and the reduction of color difference, soluble protein and soluble sugar can be inhibited better.

(5) The preservation method integrates and innovates a whole set of technical system of pretreatment, precooling, packaging, storage, marking and cold-chain transportation of the fresh tremella fuciformis, and can effectively control the production of bongkrekic acid toxin, thereby ensuring the quality safety of the fresh tremella fuciformis.

(6) The preservation method is simple, practical and high in operability.

### BRIEF DESCRIPTION OF THE DRAWINGS

FIG. 1 illustrates the influence of different precooling methods on a center temperature of fresh tremella fuciformis according to an embodiment of the present disclosure;

FIG. 2 illustrates the influence of different packaging methods on a respiratory intensity of fresh tremella fuciformis according to an embodiment of the present disclosure;

FIG. 3 illustrates the influence of different packaging methods on a weight loss rate of fresh tremella fuciformis according to an embodiment of the present disclosure;

FIG. 4 illustrates the influence of different packaging methods on a color difference of fresh tremella fuciformis according to an embodiment of the present disclosure;

FIG. 5 illustrates the influence of different packaging methods on a soluble protein content of fresh tremella fuciformis according to an embodiment of the present disclosure;

FIG. 6 illustrates the influence of different packaging methods on a soluble sugar content of fresh tremella fuciformis according to an embodiment of the present disclosure;

FIG. 7 illustrates a change of the respiratory intensity at different temperatures after fresh tremella fuciformis is harvested according to an embodiment of the present disclosure;

FIG. 8 illustrates the influence of different storage temperatures on the respiratory intensity of fresh tremella fuciformis according to an embodiment of the present disclosure;

FIG. 9 illustrates the influence of different storage temperatures on the weight loss rate of fresh tremella fuciformis according to an embodiment of the present disclosure;

FIG. 10 illustrates the influence of different storage temperatures on the color difference of fresh tremella fuciformis according to an embodiment of the present disclosure;

FIG. 11 illustrates the influence of different storage temperatures on the soluble protein content of fresh tremella fuciformis according to an embodiment of the present disclosure;

FIG. 12 illustrates the influence of different storage temperatures on the soluble sugar content of fresh tremella fuciformis according to an embodiment of the present disclosure;

FIG. 13 illustrates the influence of different storage temperatures on the respiratory intensity of fresh tremella fuciformis according to an embodiment of the present disclosure;

FIG. 14 illustrates the influence of different storage temperatures on the weight loss rate of fresh tremella fuciformis according to an embodiment of the present disclosure;

FIG. 15 illustrates the influence of different storage temperatures on the color difference of fresh tremella fuciformis according to an embodiment of the present disclosure;

FIG. 16 illustrates the influence of different storage temperatures on the soluble protein content of fresh tremella fuciformis according to an embodiment of the present disclosure;

FIG. 17 illustrates the influence of different storage temperatures on the soluble sugar content of fresh tremella fuciformis according to an embodiment of the present disclosure;

FIG. 18 illustrates the influence of different storage temperatures on a bongkreic acid content of fresh tremella fuciformis according to an embodiment of the present disclosure;

FIG. 19 illustrates a schematic diagram of placement of fresh tremella fuciformis with tremella bases according to an embodiment of the present disclosure;

FIG. 20 illustrates a schematic diagram of placement (in a hollow plastic basket) of fresh tremella fuciformis with fungal sticks according to an embodiment of the present disclosure; and

FIG. 21 illustrates a schematic diagram of placement (on a shelf) of fresh tremella fuciformis with fungal sticks according to an embodiment of the present disclosure.

### DETAILED DESCRIPTION OF THE EMBODIMENTS

To make the objectives, technical solutions, and advantages of the present disclosure clearer, the present disclosure will be further described below in detail with reference to the accompanying drawings and embodiments. It should be understood that the specific embodiments described here are merely used to explain the present disclosure, rather than limiting the present disclosure.

On the contrary, the present disclosure covers any substitutes, modifications, equivalent methods and solutions made within the spirit and scope of the present disclosure as defined by the claims. Further, in order to make the public have a better understanding of the present disclosure, some specific details are described in detail in the following detailed description of the present disclosure. For those skilled in the art, the present disclosure can be completely understood without the description of these details.

An embodiment of the present disclosure provides a preservation method of fresh tremella fuciformis suitable for cold-chain circulation, wherein the fresh tremella fuciformis is a fresh tremella fuciformis fruiting body with and without tremella bases or with fungal sticks, and the method comprises:
pretreatment of fresh tremella fuciformis: selecting fresh tremella fuciformis with no mildew, no rot, no disease and insect pests, and water content≤90% to enter subsequent cold-chain circulation, wherein the pretreatment of the fresh tremella fuciformis is completed within 2 h after the fresh tremella fuciformis is picked;
precooling: precooling the pretreated fresh tremella fuciformis put in a cold store at 1° C.-3° C., wherein a center temperature of the fresh tremella fuciformis at a stack center is precooled to 3° C.-5° C. within h; or performing vacuum precooling on the pretreated fresh tremella fuciformis, wherein the center temperature of the fresh tremella fuciformis at a stack center is precooled to 3° C.-5° C. within 40 min;
packaging: wherein a temperature of a packaging operation room of the fresh tremella fuciformis is less than or equal to 18° C., time of the fresh tremella fuciformis from entering the packaging operation room to the completion of packaging does not exceed 1 h, and packaging is completed within 48 h after precooling;
storage: storing the packaged fresh tremella fuciformis immediately, controlling a storage temperature to 1° C.-3° C., and performing cold-chain transportation within 24 h; and
cold-chain transportation: transporting the fresh tremella fuciformis by a refrigerated vehicle or by adding ice packs, and treating or refrigerating and freezing the fresh tremella fuciformis timely after the fresh tremella fuciformis arrives at a destination.

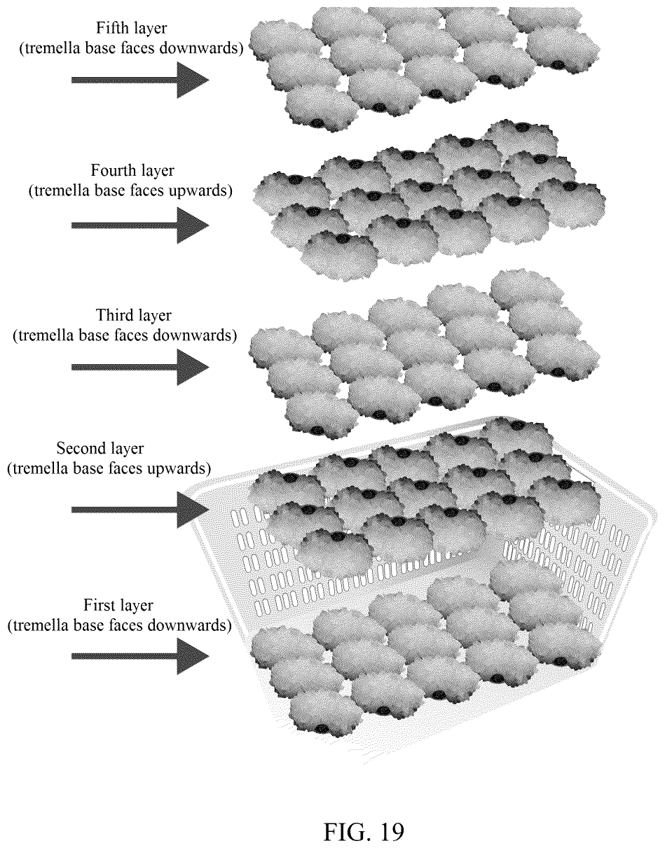

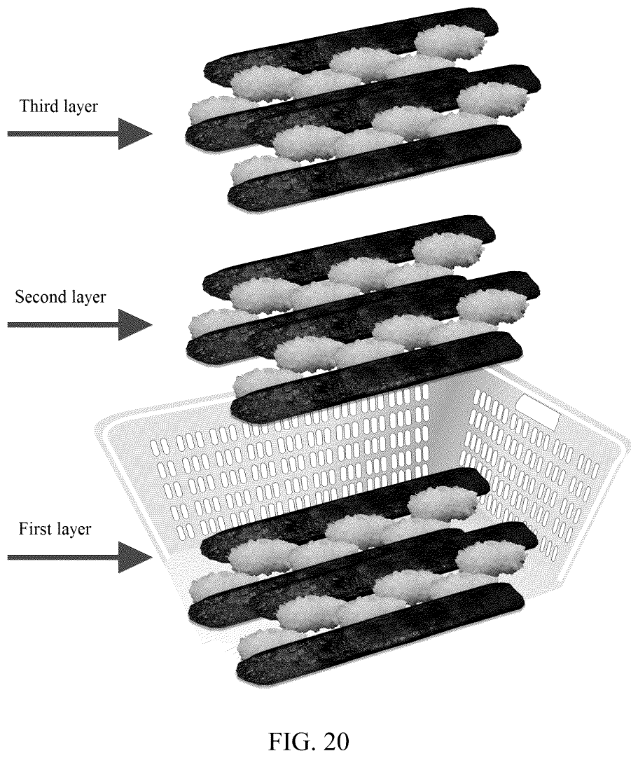

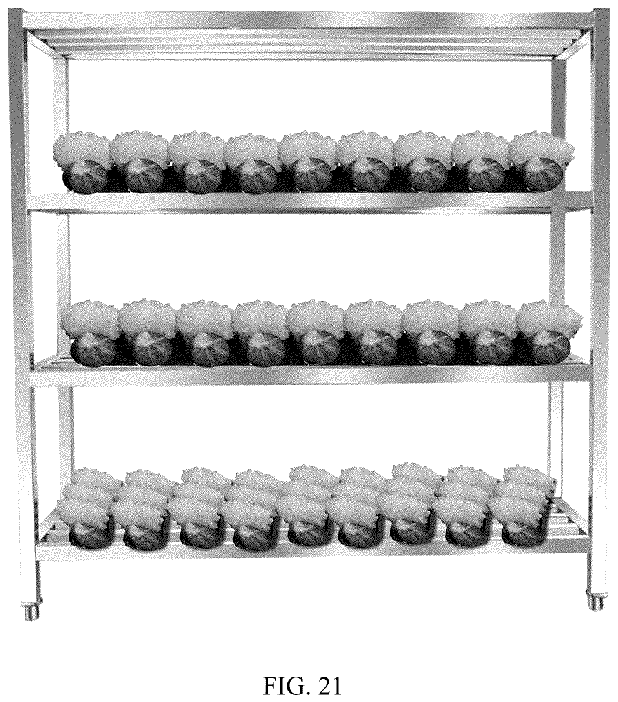

In the embodiment, the pretreatment step of the fresh tremella fuciformis further comprises: selecting a clean and dry hollow plastic turnover box that complies with the regulations of GB/T 39907 to place fresh tremella fuciformis with and without tremella bases; or selecting a clean and dry shelf to place fresh tremella fuciformis with fungal sticks, wherein a width of the shelf is greater than or equal to 30 cm, a height of the shelf is less than or equal to 200 cm, and a height between adjacent layers of each shelf is greater than or equal to 25 cm;
transversely placing the fresh tremella fuciformis with tremella bases layer by layer in a manner of tremella base to tremella base, with no more than 5 layers in each box, as shown in FIG. 19; randomly arranging the fresh tremella fuciformis without tremella bases, with a stacking height that does not exceed 30 cm; and
laterally placing the fresh tremella fuciformis with fungal sticks layer by layer in a manner of tremella slice crossed to tremella slice and stick back to stick back, with no more than 3 layers in each box, as shown in FIG. 20; or placing the fresh tremella fuciformis side by side on the shelf in a manner of the tremella bases facing downwards, with one layer of the fresh tremella fuciformis placed on each layer of shelf, as shown in FIG. 21.

In the precooling step according to the embodiment:
during precooling in the cold store: precooling the fresh tremella fuciformis placed and stacked in the hollow plastic turnover box, and controlling a distance between a stack and a wall to be greater than or equal to 30 cm, a distance between the stack and the ground to be greater than or equal to 10 cm, a distance between the stack and a top lighting lamp to be greater than or equal to 50 cm, a distance between the stack and an air cooler to be greater than or equal to 150 cm, a distance between stacks to be greater than or equal to 30 cm and a stack height to be less than or equal to 200 cm; precooling the fresh tremella fuciformis placed on the shelf, and controlling a distance between the shelf and a wall to be greater than or equal to 30 cm, a distance between the shelf and a top lighting lamp to be greater than or equal to 50 cm, a distance between the shelf and an air cooler to be greater than or equal to 150 cm and a distance between shelves to be greater than or equal to 30 cm; and
during vacuum precooling, a loading rate should not be exceeded 70%, and a vacuum degree should be maintained between 650 Pa and 750 Pa.

The packaging materials used in the packaging step according to the embodiment, comprise an internal packaging material and an external packaging material;
a plastic packaging container or packaging paper is used as the internal packaging material; the plastic packaging container complies with the regulations of GB/T 34343, a quantity of holes punched in a surface of each plastic packaging container is greater than or equal to 4, and an area of each hole is greater than or equal to 0.25 cm 2; the packaging paper complies with the regulations of NY/T 658-2015 5.4; and
a foam logistics packaging container, a plastic logistics packaging container or a carton is used as the external packaging material; the foam logistics packaging container and the plastic logistics packaging container comply with the regulations of GB/T 34344; and the carton transported by adding the ice packs complies with the regulations of GB/T 6543, and the carton transported by the refrigerated vehicle complies with the regulations of GB/T 31550.

In the packaging step according to the embodiment:
a packaging method for the fresh tremella fuciformis with and without tremella bases is as follows:
internal packaging: fresh tremella fuciformis with and without a tremella base is subjected to or not subjected to internal packaging; during internal packaging, each transparent plastic packaging container is filled with one or more fresh tremella fuciformis, and each piece of packaging paper packs one fresh tremella fuciformis with the tremella base;
external packaging: the foam logistics packaging container or the plastic logistics packaging container is used for single-layer packaging, or the foam logistics packaging container and the carton are used sequentially from inside to outside for double-layer packaging; or
when external packaging is used in transportation by adding ice packs, the ice packs are placed inside and should be placed uniformly and neatly; each fresh tremella fuciformis with or without the tremella base, which is subjected to internal packaging is equipped with an ice pack not less than 33 g, and each fresh tremella fuciformis with or without the tremella base, which is not subjected to internal packaging is equipped with an ice pack not less than 15 g;
a packaging method for the fresh tremella fuciformis with a fungal stick is:
internal packaging is not necessary for the fresh tremella fuciformis with the fungal stick;
external packaging: the foam or plastic logistic packaging container is used for single-layer packaging, or the foam logistics packaging container and the carton are used sequentially from inside to outside for double-layer packaging; or
when transporting the fresh tremella fuciformis with a fungal stick by adding ice packs, the ice packs are placed inside and should be placed uniformly and neatly; and each fresh tremella fuciformis with the fungal stick should be equipped with an ice pack not less than 27 g.

In the storage step according to the embodiment,
the fresh tremella fuciformis with external packaging completed should be stored immediately and is transported in cold chain within 24 h;
storage facilities, equipment and appliances should be kept clean and sanitary, and free of pollution, sundries and peculiar smell;
the storage temperature should be controlled between 1° C. and 3° C., the temperature in the cold store is observed and recorded regularly during storage, and records should be kept for at least two years; and
the fresh tremella fuciformis is stacked in batches according to different production batches during storage, the stacking method is as same as that used in the precooling process of the cold store, and the origin, harvest time, warehousing time, warehousing quantity and warehousing people are marked.

In the embodiment, the method further comprises a marking step, wherein marking is performed after the storage step, internal packaging marking refers to the regulation of Administrative Measures for the Packaging and Marking of Agricultural Products (Order of the Ministry of Agriculture, No. 70), and the receipt and delivery mark of the external packaging complies with the regulations of GB/T 6388; and the storage and transportation graphic mark of external packaging complies with the regulations of GB/T 191.

In the cold-chain transportation step according to the embodiment:
an appropriate transportation tool is selected according to the quality guarantee requirements of the fresh tremella fuciformis and customer requirements, a heat-insulating vehicle and the refrigerated vehicle comply with the regulations of QC/T 449, a refrigerated container complies with the regulations of GB/T 7392, and a railway freight car complies with the regulations of GB/T 5600;
transportation tools should be clean, sanitary, free of pollution, sundries and peculiar smell, and equipped with sunproof, rainproof and windproof facilities;
when transporting the fresh tremella fuciformis by the refrigerated vehicle, the temperature in a compartment needs be precooled to 4° C. or below before loading, the temperature in the compartment during transportation should be controlled between 0° C. and 4° C., the temperature in the compartment is monitored and recorded manually or by a temperature recorder, and the transportation information records should be kept for at least two years;
when transporting the fresh tremella fuciformis by adding ice packs, the fresh tremella fuciformis subjected to double-layer external packaging with the foam logistics packaging container and the carton or subjected to single-layer external packaging with the foam logistic packaging container should be transported and delivered within 48 h, and the fresh tremella fuciformis subjected to single-layer external packaging with plastic logistics packaging container should be transported and delivered within 1 h.

In the embodiment, the pretreatment of the fresh tremella fuciformis, i.e., the precooling pretreatment, defines that the fresh tremella fuciformis should be free from mildew, rot, damage, diseases and insect pests, and deformity. In the subsequent precooling period, the fresh tremella fuciformis with scars and diseases and insect pests may suffer from browning or produce peculiar smell due to its metabolism and the activities of spoilage microorganisms to result in spoilage and deterioration, which may infect other good tremella fuciformis, thereby reducing the color, aroma, taste and nutritional quality until spoilage or deterioration occurs. Therefore, the tremella fuciformis cannot be eaten at all. The tremella fuciformis with deformed appearance is not suitable for fresh sales due to the appearance quality, so that the tremella fuciformis with deformed appearance is not suitable for cold-chain circulation and should be rejected during selection. Furthermore, it is defined that the water content of the fresh tremella fuciformis is inadvisable to exceed 90% in the pretreatment step. Before the fresh tremella fuciformis enters cold-chain transportation, the water content may greatly affect the quality and the storage and preservation effect of the fresh tremella fuciformis in the cold-chain transportation. Experiments and production practice (specially as shown in Table 1) show that under the conditions of room temperature, 14° C. and 3° C., the lower the water content of the fresh tremella fuciformis, the longer the preservation time; and under the condition of the same water content, the lower the storage temperature of the fresh tremella fuciformis, the longer the preservation time. When the water content of the fresh tremella fuciformis is greater than 90%, the preservation time is obviously shortened, and it is more likely to breed microorganisms, resulting in autolysis and rot; and when the water content of the fresh tremella fuciformis is less than 75%, the preservation time is obviously prolonged, but the color is obviously yellow and the appearance quality becomes worse. However, some consumers require fresh tremella fuciformis with relatively low water content, so that the lower limit of the water content of the fresh tremella fuciformis is not defined. Therefore, it is defined that the fresh tremella fuciformis should keep the original water of the mushroom body, and the water content is inadvisable to exceed 90%.

TABLE 1
Shelf life of fresh tremella fuciformis with different
water contents at different temperatures

| | Shelf Life (d) | | |
|---|---|---|---|
| | Room | | |
| Water | temperature | | |
| Content | (25° C.) | 14° C. | 3° C. |
| 95% | 1 | 2 | 4 |
| 90% | 1 | 3 | 7 |
| 85% | 2 | 3 | 9 |
| 80% | 2 | 4 | 10 |
| 75% | 2 | 5 | 11 |
| 70% | 2 | 5 | 12 |

In the pretreatment step, it is also defined that the hollow plastic turnover box containing the fresh tremella fuciformis should be clean and dry. The fresh tremella fuciformis with tremella bases are transversely placed layer by layer in a manner of tremella slice to tremella slice and tremella base to tremella base, with no more than 5 layers in each box, wherein the tremella slice on the bottom layer faces upwards. The fresh tremella fuciformis without tremella bases are randomly arranged, with no more than 5 layers in each box. The unharvested fresh tremella fuciformis with fungal sticks are laterally placed layer by layer in a manner of tremella slice crossed to tremella slice and stick back to stick back, with no more than 3 layers in each box. Too big plastic box may lead to non-uniform precooling of the fresh tremella fuciformis and longer precooling time of the tremella fuciformis in the middle, while a large number of plastic boxes are required if a plastic box is too small. By use of the hollow plastic box, high ventilation performance is achieved and the subsequent precooling is uniform. More than 5 layers of fresh tremella fuciformis with and without tremella bases in each box, or more than 3 layers of unharvested fresh tremella fuciformis with fungal sticks may affect the precooling of the fresh tremella fuciformis in the middle of the plastic box.

Fresh tremella fuciformis, like other organisms, is still living body with life and will continue to grow and age. Therefore, timely precooling is the most critical link for cold-chain circulation of the fresh tremella fuciformis. If this link is not handled well, the storage quality of the fresh tremella fuciformis and the time of cold-chain circulation may be greatly affected. The timely precooling can eliminate or basically eliminate the field heat of the fresh tremella fuciformis so as to keep high freshness. The present disclosure compares the influences of four precooling methods, cold store precooling, vacuum precooling, ice water precooling and crushed ice precooling, on a drop rate of the center temperature and a weight loss rate of the fresh tremella fuciformis.

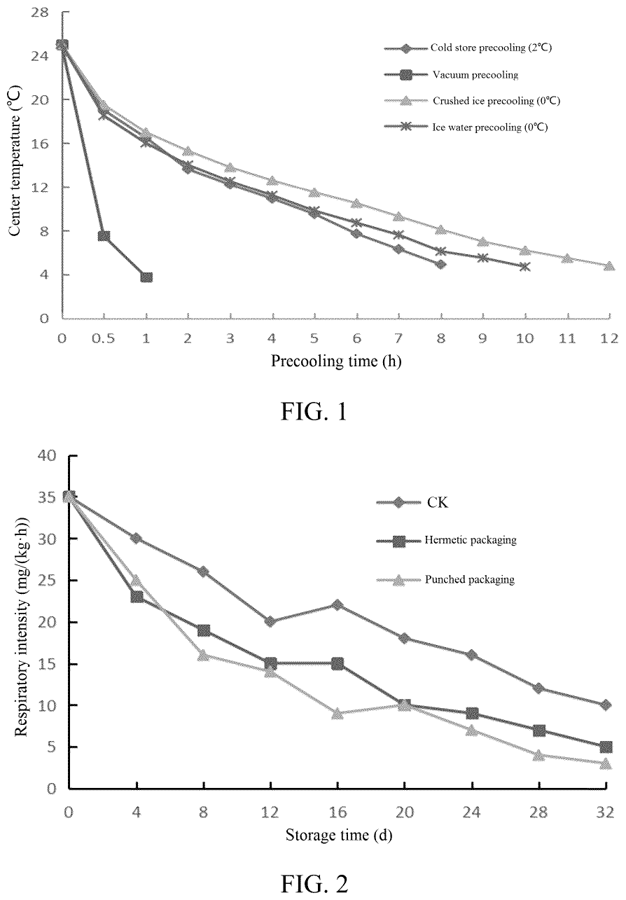

The influence results of different precooling methods on the center temperature of the fresh tremella fuciformis show (as shown in FIG. 1) that, the drop rates of the center temperature of the fresh tremella fuciformis are different in the four precooling methods. In the vacuum precooling method, the drop rate of the center temperature of the fresh tremella fuciformis is the highest, generally, the center temperature of the fresh tremella fuciformis can be reduced to 3° C.-5° C. within 40 min to 60 min; and it takes 8 h, 12 h and 10 h to reduce the center temperature of the fresh tremella fuciformis to 3° C.-5° C. under the cold store precooling, crushed ice precooling and cold water precooling methods respectively. The ordinary cold store has simple precooling equipment with the lowest operating cost; vacuum precooling is high in cooling speed and high in production efficiency, the internal and external temperatures of the precooled fresh tremella fuciformis are uniform, operation is simple, operating cost is low, but equipment is expensive; and by the cold water cooling method and the crushed ice cooling method, the fresh tremella fuciformis can absorb a large amount of water easily during precooling, cannot be applied to refrigeration and is easily infected with microorganisms, so that the cold water cooling method and the crushed ice cooling method are not suitable for cold-chain transportation.

Therefore, the present disclosure defines that the precooling method of the fresh tremella fuciformis is advisable to use the cold store precooling method or the vacuum precooling method instead of cold water or crushed ice cooling precooling.

In the precooling step according to the embodiment, it is defined that the fresh tremella fuciformis subjected to precooling pretreatment is precooled by cold store and should be placed in a cold store at 1° C.-3° C. for precooling. Stacking should be stable, a distance between a stack and a wall should be greater than or equal to 30 cm, a distance between the stack and the ground should be greater than or equal to 10 cm, a distance between the stack and a top lighting lamp should be greater than or equal to 50 cm, a distance between the stack and an air cooler should be greater than or equal to 150 cm, a distance between the stacks should be greater than or equal to 30 cm, and a stack height should be less than or equal to 200 cm. A gap is reserved between the stacks to make cold air in the cold store circulate more smoothly, and the fresh tremella fuciformis is precooled more uniformly. The stack is inadvisable to be excessively high, because the excessively high stack is inconvenient to carry and circulation of cold air in the cold store is not smooth enough to affect the precooling uniformity. Furthermore, in the precooling step according to the present disclosure, it is defined that precooling is stopped when the center temperature of the fresh tremella fuciformis at the center of the stack is reduced to 3° C.-5° C. When the center temperature of the fresh tremella fuciformis reaches 3° C.-5° C. as required, field heat has been basically eliminated, the respiratory rate and the metabolism rate are greatly reduced, the generated heat is low, and precooling can be stopped at the moment, and the fresh tremella fuciformis is transferred to a cold store for storage, thereby ensuring the freshness of the fresh tremella fuciformis. If the fresh tremella fuciformis enters the cold store for storage when the center temperature does not reach 3° C.-5° C., a respiratory intensity of the fresh tremella fuciformis is not inhibited well, metabolic activity is not weakened, and thus a large amount of respiratory heat may still be produced. The temperature of the cold store fluctuates greatly, so that the freshness of the tremella fuciformis is low.

According to the present disclosure, the packaging material is subjected to the following experiment: the precooled fresh tremella fuciformis is placed in plastic boxes (one piece in one box). One group of fresh tremella fuciformis is hermetically packaged by a non-punched preservation bag, one group of fresh tremella fuciformis is packaged by a punched preservation bag, and unpackaged fresh tremella fuciformis serves as a control group. The three groups of fresh tremella fuciformis are all placed in a cold store with the temperature of 2° C. and relative humidity of 90% for storage and preservation experiments.

The influence results of different packaging methods on the respiratory intensity of the fresh tremella fuciformis (as shown in FIG. 2) show that, the respiratory intensities of the fresh tremella fuciformis using different packaging methods are reduced with the extension of the storage time, and the respiratory intensity of the packaging group in the plastic box is obviously less than that of the control group, which indicates that the packaging by the plastic box is favorable for reducing the respiratory intensity of the fresh tremella fuciformis and delaying the aging process, thereby prolonging the storage period.

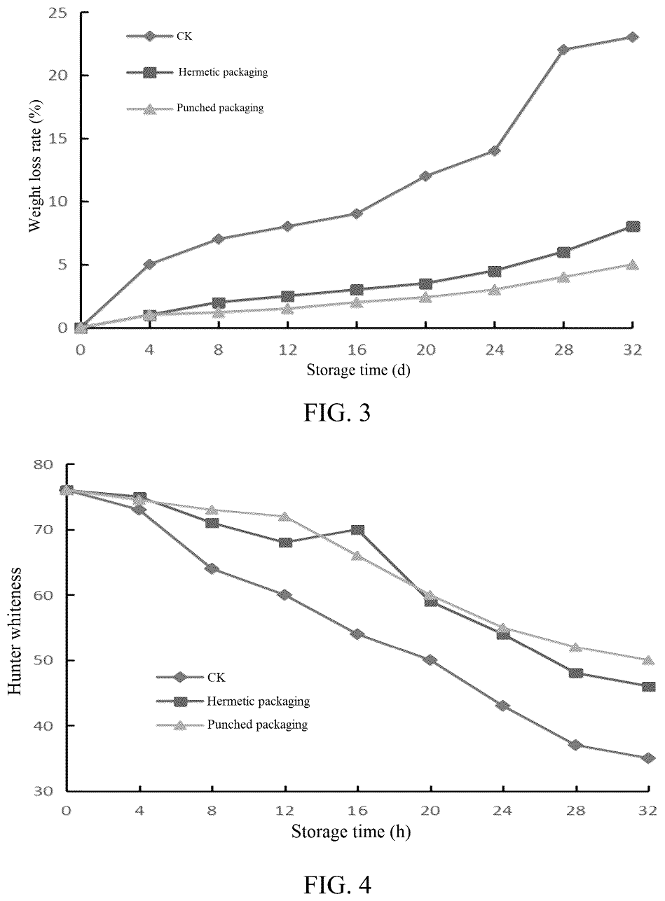

The influence results of different packaging methods on the weight loss rate of the fresh tremella fuciformis (as shown in FIG. 3) show that, the weight loss rate of the fresh tremella fuciformis using different packaging methods are increased with the extension of the storage time, the weight loss rate of the fresh tremella fuciformis in the control group is obviously higher than that of the packaging group in the plastic box, and the weight loss rate of the hermetically packaged fresh tremella fuciformis is slightly higher than that of the fresh tremella fuciformis subjected to punched packaging.

The influence results of different packaging methods on a color difference of the fresh tremella fuciformis (as shown in FIG. 4) show that, the whiteness of the fresh tremella fuciformis is reduced with the extension of the storage time, a whiteness value of the fresh tremella fuciformis subjected to punched packaging is totally large and is reduced slightly.

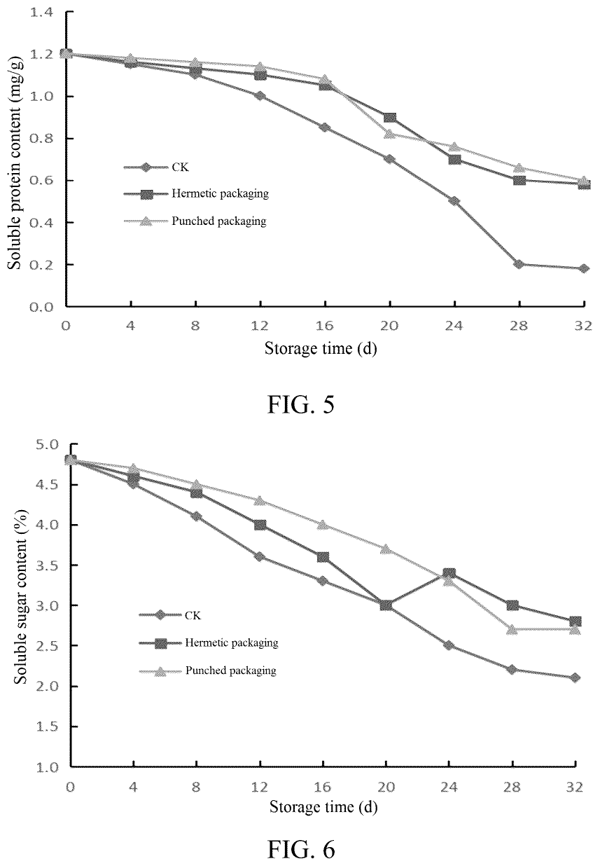

The influence results of different packaging methods on a soluble protein content of the fresh tremella fuciformis (as shown in FIG. 5) show that, the soluble protein content of the fresh tremella fuciformis is gradually reduced with the extension of the storage time, and the soluble protein content of the control group is reduced most obviously.

The influence results of different packaging methods on a soluble sugar content of the fresh tremella fuciformis (as shown in FIG. 6) show that, the soluble sugar content of the fresh tremella fuciformis is consumed to be reduced with the extension of the storage time, and the control group has the worst effect of inhibiting the reduction of the soluble sugar content of the fresh tremella fuciformis.

In conclusion, the storage and preservation experiment results of the fresh tremella fuciformis that packaged in the three packaging methods: no packaging, plastic box hermetic packaging and plastic box punched packaging, under the temperature of 2° C. and the relative humidity of 90% show that, the plastic box punched packaging has the best effect of inhibiting the respiratory intensity and the weight loss rate of the fresh tremella fuciformis, and can better inhibit the reduction of color difference, soluble content and soluble sugar. Therefore, according to the present disclosure, the internal packaging is in direct contact with the fresh tremella fuciformis, so the internal packaging must be safe and free from toxicity. The fresh tremella fuciformis tends to ferment in a closed environment to produce wine taste or sour taste to affect the product quality, so that it is necessary to select a packaging material with high air permeability. Therefore, it is very necessary to define the packaging material in the present disclosure.

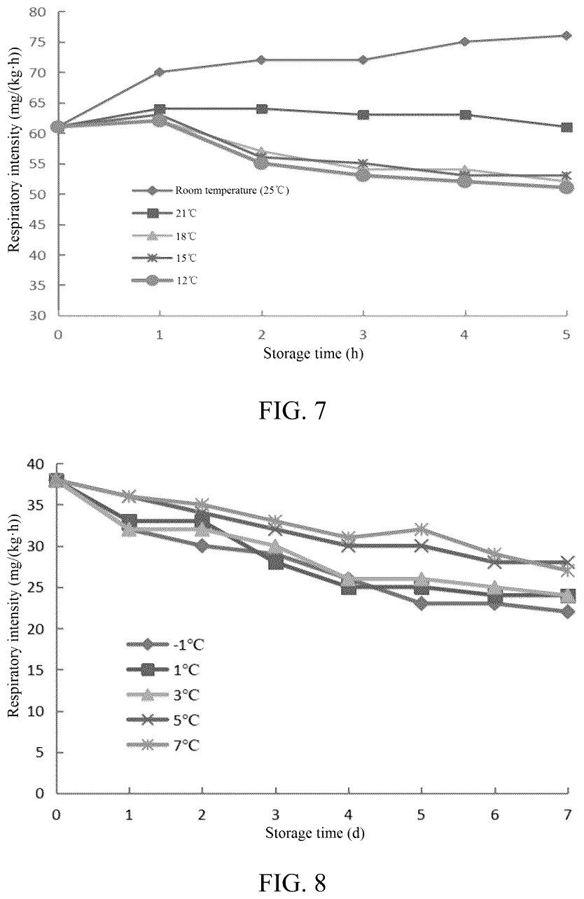

In the embodiment, when the internal packaging is defined, the temperature of an operation room is controlled between 15° C. and 18° C. and the operation time is inadvisable to exceed 1 h. The results of study on the changes of the respiratory intensity of fresh tremella fuciformis at different temperatures after harvesting (specifically as shown in FIG. 7) show that, the respiratory intensity of the fresh tremella fuciformis stored at normal temperature (25° C.) is increased sharply first and then is increased slowly; the respiratory intensity of the fresh tremella fuciformis stored at 21° C. is greatly increased and then is reduced slowly; the respiratory intensity of the fresh tremella fuciformis stored at 18° C., 15° C. and 12° C. is slightly increased and then is reduced, and there is no significant difference in the changes of the respiratory intensity at the three temperatures; and the results show that the relative low temperatures (18° C., 15° C. and 12° C.) have the effect of inhibiting the respiration of the fresh tremella fuciformis. In addition, the excessively high temperature of the operation room may easily produce the quality deterioration of the tremella fuciformis and the pollution risk of bongkreic acid; and if the temperature is excessively low (15° C. or below), an operator cannot bear the temperature, so that the temperature of the operation room during internal packaging should be controlled between 15° C. and 18° C.

In the present disclosure, the following experiment is performed on the fresh tremella fuciformis:
the freezing point of the fresh tremella fuciformis is −1.1° C., so that the lowest temperature is −1° C. in this experiment. According to the requirements of fresh agricultural products, the shorter the time of products from harvest to customer's hands, the better. Therefore, five temperatures of −1° C., 1° C., 3° C., and 7° C. are set, and a short-term (1 to 7 days) storage and preservation experiment of the unpackaged fresh tremella fuciformis is performed.

The influence results of different storage temperatures on the respiratory intensity of the fresh tremella fuciformis (as shown in FIG. 8) show that, the respiratory intensity of the fresh tremella fuciformis is greatly inhibited by a precooling process, and the respiratory intensity is reduced from 56 mg/(kg·h) after selection to 38 mg/(kg·h); the respiratory intensity of the fresh tremella fuciformis is reduced with the extension of the storage time, and the lower the temperature, the greater the reducing amplitude, indicating that the respiratory intensity of the fresh tremella fuciformis may be inhibited at low temperatures; and the respiratory intensity of the fresh tremella fuciformis at −1° C., 1° C. and 3° C. is reduced obviously on the first day.

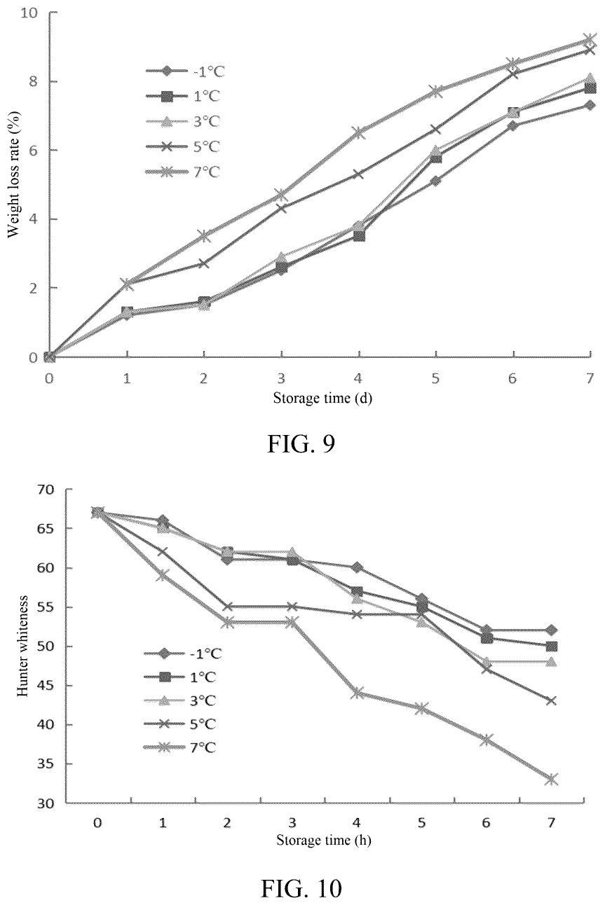

The influence results of different storage temperatures on the weight loss rate of the fresh tremella fuciformis (as shown in FIG. 9) show that, the weight loss rate of the fresh tremella fuciformis is increased with the extension of the storage time, and the higher the temperature, the greater the increasing amplitude; and the increasing amplitude of the weight loss rate of the fresh tremella fuciformis at −1° C., 1° C. and 3° C. is obviously lower than that of the weight loss rate of the fresh tremella fuciformis at 5° C. and 7° C.

The influence results of different storage temperatures on the color difference of the fresh tremella fuciformis (as shown in FIG. 10) show that, the whiteness of the fresh tremella fuciformis is reduced with the extension of the storage time, and the higher the temperature, the greater the reducing amplitude; and the reducing amplitude of the whiteness of the fresh tremella fuciformis at −1° C., 1° C. and 3° C. is obviously lower than that of the whiteness of the fresh tremella fuciformis at 5° C. and 7° C., the reducing amplitude of the whiteness of the fresh tremella fuciformis at −1° C., 1° C. and 3° C. on the first day is lower, and the whiteness of the fresh tremella fuciformis at 5° C. and 7° C. on the first day is obviously reduced.

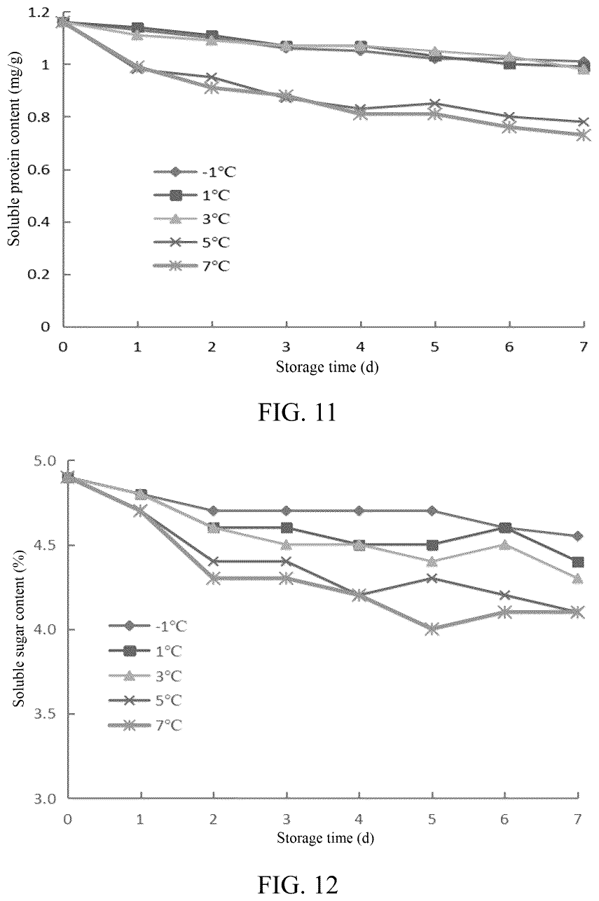

The influence results of different storage temperatures on the soluble protein content of the fresh tremella fuciformis (as shown in FIG. 11) show that, the soluble protein content of the fresh tremella fuciformis is reduced with the extension of the storage time, and the higher the temperature, the greater the reducing amplitude; and the reducing amplitude of the soluble protein content of the fresh tremella fuciformis at −1° C., 1° C. and 3° C. is obviously lower than that of the soluble protein content of the fresh tremella fuciformis at 5° C. and 7° C., the reducing amplitude of the soluble protein content of the fresh tremella fuciformis at −1° C., 1° C. and 3° C. on the first day is lower, and the soluble protein content of the fresh tremella fuciformis at 5° C. and 7° C. on the first day is obviously reduced.

The influence results of different storage temperatures on the soluble sugar content of the fresh tremella fuciformis (as shown in FIG. 12) show that, the soluble sugar content of the fresh tremella fuciformis is reduced with the extension of the storage time, and the higher the temperature, the greater the reducing amplitude; and the reducing amplitude of the soluble sugar content of the fresh tremella fuciformis at −1° C., 1° C. and 3° C. is obviously lower than that of the soluble sugar content of the fresh tremella fuciformis at 5° C. and 7° C., the reducing amplitude of the soluble sugar content of the fresh tremella fuciformis at −1° C., 1° C. and 3° C. on the first day is lower, and the soluble sugar content of the fresh tremella fuciformis at 5° C. and 7° C. on the first day is obviously reduced.

In conclusion, the results of the storage and preservation experiment of the unpackaged fresh tremella fuciformis at five temperatures of −1° C., 1° C., 3° C., 5° C. and 7° C. show that, the respiratory intensity and weight loss rate of the fresh tremella fuciformis, and the reduction of the color difference, soluble protein and soluble sugar can be better inhibited at −1° C., 1° C. and 3° C.; furthermore, the reducing amplitude of the color difference, soluble protein and soluble sugar at −1° C., 1° C. and 3° C. on the first day is lower, so that the storage temperature suitable for the fresh tremella fuciformis is −1° C.-3° C.; however, the fluctuation of the storage temperature of −1° C. easily produces that the surface of the fresh tremella fuciformis is slightly frozen, so the storage and preservation effect is affected; besides, considering energy saving, 1° C.-3° C. is selected as the storage temperature for the fresh tremella fuciformis; and the fresh tremella fuciformis with external packaging completed should be stored immediately and transported in cold chain within 24 h, so that the freshness and nutritional quality of the fresh tremella fuciformis can be kept better.

Stability is required for stacking, a distance between the stack and the wall should be greater than or equal to 30 cm, a distance between the stack and the ground should be greater than or equal to 10 cm, a distance between the stack and a top lighting lamp should be greater than or equal to 50 cm, a distance between the stack and an air cooler should be greater than or equal to 150 cm, a distance between the stacks should be greater than or equal to 30 cm, and a stack height should be less than or equal to 200 cm. The fresh tremella fuciformis should be stacked in batches according to different production batches; and the origin, harvest time, warehousing time, warehousing quantity and warehousing people are marked. Storage facilities, equipment and appliances should be kept clean and sanitary, and free of pollution, sundries and peculiar smell.

For the cold-chain transportation step in the present disclosure, transportation tools should be clean, sanitary, free of pollution and sundries, and equipped with sunproof, rainproof and windproof facilities. Transportation tools should be clean, sanitary, free of pollution, sundries and peculiar smell, and equipped with sunproof, rainproof and windproof facilities, thereby avoiding pollution to the fresh tremella fuciformis in the transportation process, and realizing no pollution and no peculiar smell. If refrigerated vehicles or refrigerated containers are used for transportation, the compartment of the transportation tools should be equipped with an automatic temperature recorder to record the temperature in the compartment in the whole transportation process. In the whole transportation process, it is necessary to monitor and control the temperature change of the fresh tremella fuciformis all the time, thereby avoiding excessive loss in the transportation process.

After the fresh tremella fuciformis sold in physical markets arrives at the distribution place, the fresh tremella fuciformis should be stored in a cold store at 1° C.-3° C. according to the experimental result of the storage step. After the fresh tremella fuciformis in the e-commerce is delivered to consumers, since the temperatures of the preservation layers of household refrigerators are basically different from each other, but are basically −5° C.-10° C., the quality changes of the fresh tremella fuciformis are studied according to the temperature interval of −5° C., 0° C., 5° C. and 10° C.

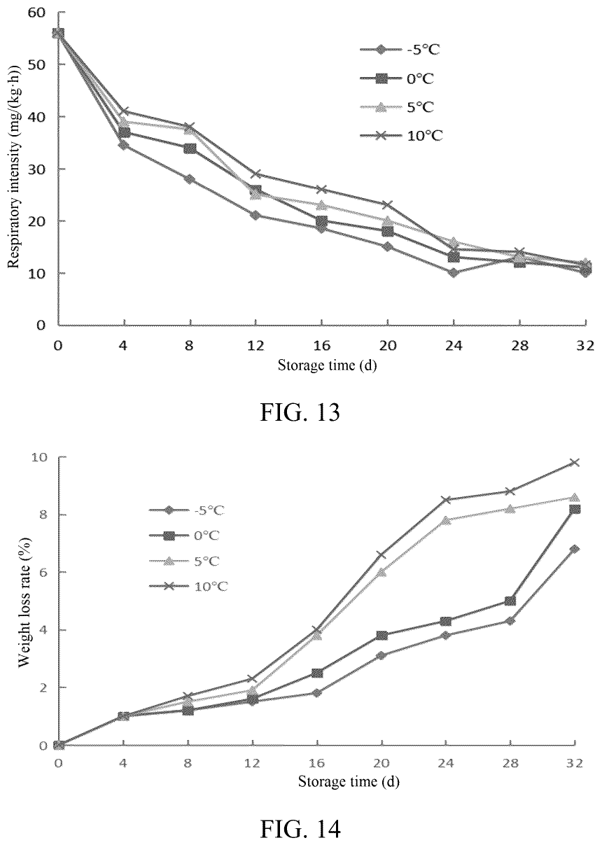

The influence results of different storage temperatures on the respiratory intensity of the fresh tremella fuciformis (FIG. 13) show that, the respiratory intensity of the fresh tremella fuciformis is reduced with the extension of the storage time, and the lower the temperature, the greater the reducing amplitude, wherein the respiratory intensity of the fresh tremella fuciformis stored at four different temperatures in an initial stage (0 to 4 days) is greatly reduced, indicating that the respiratory intensity of the fresh tremella fuciformis may be inhibited at low temperatures. After the fresh tremella fuciformis is stored at 10° C. for 20 days, the root begins to rot, the commercial value has been lost, the vital sign is weak, and the respiratory intensity is sharply reduced; and the commercial value of the fresh tremella fuciformis stored at four storage temperatures is completely lost on the 32^{nd} day.

The influence results of different storage temperatures on the weight loss rate of the fresh tremella fuciformis (FIG. 14) show that, the weight loss rate of the fresh tremella fuciformis is increased with the extension of the storage time, and the higher the temperature, the higher the weight loss rate; and the weight loss rate is increased sharply after the fresh tremella fuciformis is stored at 5° C. and 10° C. for 12 days, and after 20 days, the weight loss rate exceeds 5% and the commercial value is basically lost.

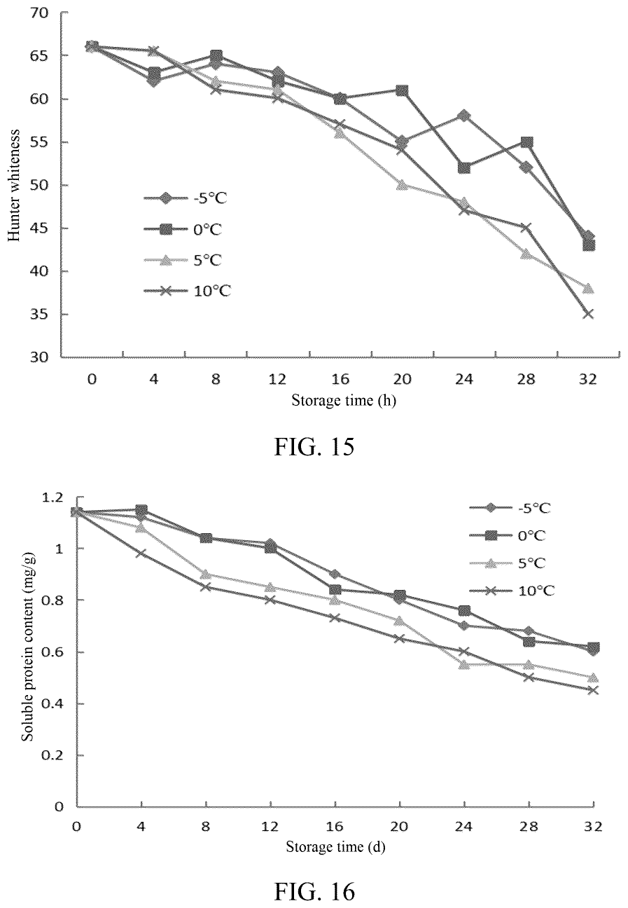

The influence results of different storage temperatures on the color difference of the fresh tremella fuciformis (FIG. 15) show that, the whiteness of the fresh tremella fuciformis at different storage temperatures is reduced with the extension of the storage time, and the higher the temperature, the greater the reducing amplitude; and the reduction of the whiteness of the fresh tremella fuciformis at the four storage temperatures is accelerated after 12 days.

The influence results of different storage temperatures on the soluble protein content of the fresh tremella fuciformis (FIG. 16) show that, the soluble protein content of the fresh tremella fuciformis at different storage temperatures is reduced with the extension of the storage time, and the higher the temperature, the greater the reducing amplitude.

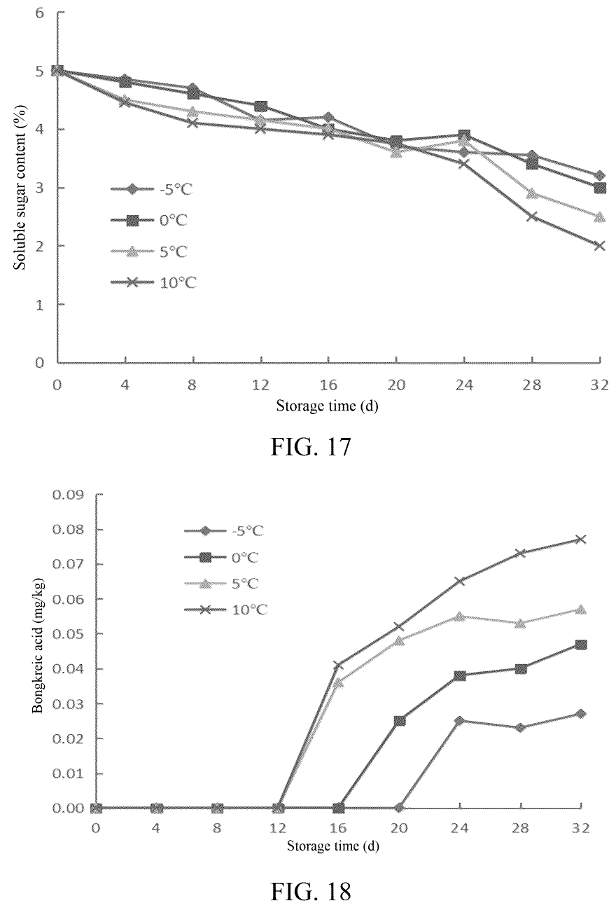

The influence results of different storage temperatures on the soluble sugar content of the fresh tremella fuciformis (FIG. 17) show that, the soluble sugar content of the fresh tremella fuciformis at different storage temperatures is reduced with the extension of the storage time.

The influence results of different storage temperatures on a bongkreic acid content of the fresh tremella fuciformis (FIG. 18) show that, the fresh tremella fuciformis begins to produce bongkreic acid after being stored at 5° C. and 10° C. for 12 days, the fresh tremella fuciformis begins to produce bongkreic acid after being stored at −5° C. and 0° C. respectively for 20 days and 16 days, but the amount of bongkreic acid produced in the whole storage period is very small, the commercial value of the fresh tremella fuciformis is completely lost on the 32^{nd} day, and the highest bongkreic acid content of the fresh tremella fuciformis stored at 10° C. is only 0.077 mg/kg, which is far lower than the limit of 0.25 mg/kg of Food Safety National Standard Edible Mushroom And Products Thereof (GB 7096).

In conclusion, the change results of the storage quality of the fresh tremella fuciformis at −5° C., 0° C., and 10° C. show that, the commercial value is basically lost after the fresh tremella fuciformis is stored at 5° C. and 10° C. for 20 days, and the commercial value is completely lost after the fresh tremella fuciformis is stored at −5° C. and 0° C. for 32 days; however, in order to eat fresh tremella fuciformis with higher quality and ensure that the fresh tremella fuciformis does not produce bongkreic acid, the setting temperature of the preservation layer of each household refrigerator is quite different from each other, so that it is suggested that the fresh tremella fuciformis should be treated or refrigerated and frozen timely after arriving at the destination. Refrigerated storage of the fresh tremella fuciformis is inadvisable to exceed 8 days, and frozen storage of the fresh tremella fuciformis is inadvisable to exceed 30 days.

In addition, in the present disclosure, during transportation by the refrigerated vehicle, the temperature in the compartment should be precooled to 4° C. or below before loading, the temperature in the compartment during transportation should be controlled between 0° C. and 4° C., and the temperature in the compartment should be observed and recorded every 2 h. During transportation by adding ice packs, the fresh tremella fuciformis subjected to double-layer external packaging of the foam logistics packaging container and the carton should be transported and delivered within 48 h, and the fresh tremella fuciformis subjected to single-layer external packaging of the foam or plastic logistics packaging container should be transported and delivered within 1 h.

1. A preservation method of fresh tremella fuciformis suitable for cold-chain circulation, wherein the fresh tremella fuciformis is a fresh tremella fuciformis fruiting body with and without tremella bases or with fungal sticks, and the method comprises:
pretreatment of fresh tremella fuciformis: selecting fresh tremella fuciformis with no mildew, no rot, no disease and insect pests, and water content≤90% to enter subsequent cold-chain circulation, wherein the pretreatment of the fresh tremella fuciformis is completed within 2 h after the fresh tremella fuciformis is picked;
precooling: precooling the pretreated fresh tremella fuciformis put in a cold store at 1° C.-3° C., wherein a center temperature of the fresh tremella fuciformis at a stack center is precooled to 3° C.-5° C. within 5 h; or performing vacuum precooling on the pretreated fresh tremella fuciformis, wherein the center temperature of the fresh tremella fuciformis is precooled to 3° C.-5° C. within 40 min;
packaging: a temperature of a packaging operation room of the fresh tremella fuciformis is less than or equal to 18° C., time of the fresh tremella fuciformis from entering the packaging operation room to the completion of packaging does not exceed 1 h, and packaging is completed within 48 h after precooling;
storage: storing the packaged fresh tremella fuciformis immediately, controlling a storage temperature to 1° C.-3° C., and performing cold-chain transportation within 24 h; and
cold-chain transportation: transporting the fresh tremella fuciformis by a refrigerated vehicle or by adding ice packs, and treating or refrigerating and freezing the fresh tremella fuciformis timely after the fresh tremella fuciformis arrives at a destination.

2. The preservation method of fresh tremella fuciformis suitable for cold-chain circulation according to claim 1, wherein the pretreatment of the fresh tremella fuciformis further comprises:
selecting a clean and dry hollow plastic turnover box that complies with the regulations of GB/T 39907 to place fresh tremella fuciformis with and without tremella bases; or selecting a clean and dry shelf to place fresh tremella fuciformis with fungal sticks, wherein a width of the shelf is greater than or equal to 30 cm, a height of the shelf is less than or equal to 200 cm, and a height between adjacent layers of each shelf is greater than or equal to 25 cm;
transversely placing the fresh tremella fuciformis with tremella bases layer by layer in a manner of tremella base to tremella base, with no more than 5 layers in each box;
randomly arranging the fresh tremella fuciformis without tremella bases, with a stacking height that does not exceed 30 cm; and
laterally placing the fresh tremella fuciformis with fungal sticks layer by layer in a manner of tremella slice crossed to tremella slice and stick back to stick back, with no more than 3 layers in each box; or
placing the fresh tremella fuciformis side by side on the shelf in a manner of the tremella bases facing downwards, with one layer of the fresh tremella fuciformis placed on each layer of shelf.

3. The preservation method of fresh tremella fuciformis suitable for cold-chain circulation according to claim 1, wherein in the precooling step:
during precooling in the cold store: precooling the fresh tremella fuciformis placed and stacked in the hollow plastic turnover box, and controlling a distance between a stack and a wall to be greater than or equal to 30 cm, a distance between the stack and the ground to be greater than or equal to 10 cm, a distance between the stack and a top lighting lamp to be greater than or equal to 50 cm, a distance between the stack and an air cooler to be greater than or equal to 150 cm, a distance between stacks to be greater than or equal to 30 cm and a stack height to be less than or equal to 200 cm; precooling the fresh tremella fuciformis placed on the shelf, and controlling a distance between the shelf and a wall to be greater than or equal to 30 cm, a distance between the shelf and a top lighting lamp to be greater than or equal to 50 cm, a distance between the shelf and an air cooler to be greater than or equal to 150 cm and a distance between shelves to be greater than or equal to 30 cm; and
during vacuum precooling, a loading rate should not be exceeded 70%, and a vacuum degree should be maintained between 650 Pa and 750 Pa.

4. The preservation method of fresh tremella fuciformis suitable for cold-chain circulation according to claim 1, wherein packaging materials used in the packaging step comprise an internal packaging material and an external packaging material;
a plastic packaging container or packaging paper is used as the internal packaging material; the plastic packaging container complies with the regulations of GB/T 34343, a quantity of holes punched in a surface of each plastic packaging container is greater than or equal to 4, and an area of each hole is greater than or equal to 0.25 cm 2; the packaging paper complies with the regulations of NY/T 658-2015 5.4; and
a foam logistics packaging container, a plastic logistics packaging container or a carton is used as the external packaging material; the foam logistics packaging container and the plastic logistics packaging container comply with the regulations of GB/T 34344; and the carton transported by adding the ice packs complies with the regulations of GB/T 6543, and the carton transported by the refrigerated vehicle complies with the regulations of GB/T 31550.

5. The preservation method of fresh tremella fuciformis suitable for cold-chain circulation according to claim 4, wherein in the packaging step:
a packaging method for the fresh tremella fuciformis with and without tremella bases is as follows:
(1) internal packaging: fresh tremella fuciformis with and without a tremella base is subjected to or not subjected to internal packaging; during internal packaging, each transparent plastic packaging container is filled with one or more fresh tremella fuciformis, and each piece of packaging paper packs one fresh tremella fuciformis with the tremella base;
(2) external packaging: the foam logistics packaging container or the plastic logistics packaging container is used for single-layer packaging, or the foam logistics packaging container and the carton are used sequentially from inside to outside for double-layer packaging; or
when external packaging is used in transportation by adding ice packs, the ice packs are placed inside and should be placed uniformly and neatly; each fresh tremella fuciformis with or without the tremella base, which is subjected to internal packaging is equipped with an ice pack not less than 33 g, and each fresh tremella fuciformis with or without the tremella base, which is not subjected to internal packaging is equipped with an ice pack not less than 15 g;
a packaging method for the fresh tremella fuciformis with a fungal stick is:
(1) internal packaging is not necessary for the fresh tremella fuciformis with the fungal stick;
(2) external packaging: the foam or plastic logistic packaging container is used for single-layer packaging, or the foam logistics packaging container and the carton are used sequentially from inside to outside for double-layer packaging; or
when transporting the fresh tremella fuciformis with a fungal stick by adding ice packs, the ice packs are placed inside and should be placed uniformly and neatly; and each fresh tremella fuciformis with the fungal stick should be equipped with an ice pack not less than 27 g.

6. The preservation method of fresh tremella fuciformis suitable for cold-chain circulation according to claim 1, wherein in the storage step,
the fresh tremella fuciformis with external packaging should be stored immediately and is transported in cold chain within 24 h; and the storage temperature should be controlled between 1° C. and 3° C.

7. The preservation method of fresh tremella fuciformis suitable for cold-chain circulation according to claim 1, further comprising a marking step, wherein marking is performed after the storage step, internal packaging marking refers to the regulation of Administrative Measures for the Packaging and Marking of Agricultural Products (Order of the Ministry of Agriculture, No. 70), and the receipt and delivery mark of the external packaging complies with the regulations of GB/T 6388; and the storage and transportation graphic mark of external packaging complies with the regulations of GB/T 191.

8. The preservation method of fresh tremella fuciformis suitable for cold-chain circulation according to claim 1, wherein in the cold-chain transportation step:
an appropriate transportation tool is selected according to the quality guarantee requirements of the fresh tremella fuciformis and customer requirements, a heat-insulating vehicle and the refrigerated vehicle comply with the regulations of QC/T 449, a refrigerated container complies with the regulations of GB/T 7392, and a railway freight car complies with the regulations of GB/T 5600;
when transporting the fresh tremella fuciformis by the refrigerated vehicle, the temperature in a compartment should be precooled to 4° C. or below before loading, and the temperature in the compartment during transportation should be controlled between 0° C. and 4° C.; and
when transporting the fresh tremella fuciformis by adding ice packs, the fresh tremella fuciformis subjected to double-layer external packaging with the foam logistics packaging container and the carton or subjected to single-layer external packaging with the foam logistic packaging container should be transported and delivered within 48 h, and the fresh tremella fuciformis subjected to single-layer external packaging with plastic logistics packaging container should be transported and delivered within 1 h.
